(19) United States
(12) Patent Application Publication
(10) Pub. No.: US 2025/0337100 A1
(43) Pub. Date: Oct. 30, 2025

(54) BATTERY MODULE COMPRISING BARRIER AND BATTERY PACK COMPRISING THE SAME

(71) Applicant: SK On Co., Ltd., Seoul (KR)

(72) Inventors: Seo Roh RHEE, Daejeon (KR); Jae Sik KIM, Daejeon (KR); Seung Dong LEE, Daejeon (KR); Sung Min HONG, Daejeon (KR)

(21) Appl. No.: 19/190,802

(22) Filed: Apr. 28, 2025

(30) Foreign Application Priority Data
Apr. 29, 2024 (KR) 10-2024-0056994

(51) Int. Cl. H01M 50/383; H01M 10/658; H01M 50/211; H01M 50/30; H01M 50/342

(52) U.S. Cl. CPC H01M 50/383; H01M 10/658; H01M 50/211; H01M 50/3425; H01M 50/394

(57) ABSTRACT

A battery module includes a cell assembly including a plurality of battery cells; a module housing accommodating the cell assembly and including a plurality of venting holes; a first barrier disposed on an inner surface of the module housing and including a plurality of first venting portions configured to deform based on pressure inside the module housing; and a second barrier disposed on an outer surface of the module housing and including a plurality of through-holes. At least a portion 10 of gas generated in the cell assembly is configured to be discharged to an outside of the module housing through the plurality of first venting portions, the plurality of venting holes, and the plurality of through-holes.

### CROSS-REFERENCE TO RELATED APPLICATION(S)

This patent document claims the priority and benefits of Korean Patent Application No. 10-2024-0056994 filed on Apr. 29, 2024, the disclosure of which is incorporated herein by reference in its entirety.

### TECHNICAL FIELD

The disclosure and implementations disclosed in this patent document generally relate to a battery module including a barrier and a battery pack including the same.

### BACKGROUND

Secondary batteries, unlike primary batteries, may be charged and discharged, and may be applied to various fields such as digital cameras, mobile phones, laptops, hybrid cars, electric cars, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid square or cylindrical can-type battery cells. A plurality of battery cells may be formed into a cell assembly in a stacked form.

The cell assembly may be disposed inside a module housing to form a battery module, and a plurality of battery modules may be disposed inside a pack frame to form a battery pack.

### SUMMARY

The present disclosure may be implemented in some embodiments to provide a battery pack including a plurality of battery modules, a pack frame accommodating the plurality of battery modules, and a pack cover covering the plurality of battery modules. However, flames, gases, or conductive particles discharged from a battery module may be reflected after contacting the pack cover and may be transmitted to other battery modules.

According to an aspect of the present disclosure, a battery module and a battery pack capable of preventing a rebound effect due to a structure of a battery pack (for example, a pack cover) may be provided.

According to an aspect of the present disclosure, a battery module and a battery pack capable of delaying heat transmission between battery modules and preventing heat runaway between battery modules may be provided.

The battery module and the battery pack of the present disclosure may be widely applied in green technology fields such as electric vehicles, battery charging stations, and other solar power generation and wind power generation using batteries. In addition, the battery module and the battery pack of the present disclosure may be used in eco-friendly electric vehicles and hybrid vehicles, and the like, to prevent climate change by suppressing air pollution and greenhouse gas emissions.

In some embodiments of the present disclosure, a battery module includes a cell assembly including a plurality of battery cells; a module housing accommodating the cell assembly and including a plurality of venting holes; a first barrier disposed on an inner surface of the module housing and including a plurality of first venting portions configured to deform based on pressure inside the module housing; and a second barrier disposed on an outer surface of the module housing and including a plurality of through-holes. At least a portion of gas generated in the cell assembly is configured to be discharged to an outside of the module housing through the plurality of first venting portions, the plurality of venting holes, and the plurality of through-holes.

In an embodiment, the plurality of venting holes may be positioned between the plurality of first venting portions and the plurality of through-holes, respectively.

In an embodiment, the plurality of first venting portions may each include a first deformable portion formed in a notching, half-cut, engraving, or plate shape.

In an embodiment, the battery module may include a buffer pad disposed on the second barrier and configured to contact an external structure of the battery module.

In an embodiment, the first barrier may include at least one of glass fiber, silicon, ceramic, or aerogel.

In an embodiment, the second barrier may include at least one of mica and mineral fiber.

In an embodiment, the battery module may further include an adhesive layer including a first adhesive layer connecting the first barrier and the module housing, and a second adhesive layer connecting the second barrier and the module housing.

According to an embodiment, the first adhesive layer may include a first hole positioned between the plurality of venting holes and the plurality of first venting portions, and the second adhesive layer may include a second hole positioned between the plurality of venting holes and the plurality of through-holes.

According to an embodiment, the battery module may further include a third barrier disposed between the second barrier and the module housing and including a plurality of second venting portions configured to be deformed based on pressure inside the module housing. The plurality of second venting portions may face the plurality of venting holes. The plurality of second venting portions may each include a second deformable portion formed in a notching, half-cut, engraving, or plate shape.

According to an embodiment, the battery module may further include an adhesive layer including a first adhesive layer connecting the first barrier and the module housing, a second adhesive layer connecting the second barrier and the third barrier, and a third adhesive layer connecting the third barrier and the module housing.

In an embodiment, the third barrier may include at least one of glass fiber, silicon, ceramic, or aerogel.

In an embodiment, the module housing may include a module cover covering the cell assembly and having the plurality of venting holes formed therein. The first barrier may be disposed on an inner surface of the module cover. The second barrier may be disposed on an outer surface of the module cover.

In an embodiment, the module housing may include a main plate supporting the cell assembly and a side wall extending from the main plate and having the plurality of venting holes formed therein. The first barrier may be disposed on an inner surface of the side wall, and the second barrier may be disposed on an outer surface of the side wall.

In some embodiments of the present disclosure, a battery pack includes a plurality of battery modules; and a pack frame accommodating the plurality of battery modules. Each of the plurality of battery modules includes a cell assembly including a plurality of battery cells, a module housing accommodating the cell assembly and including a plurality of venting holes, a first barrier disposed on an inner surface of the module housing and including a plurality of first venting portions configured to deform based on pressure inside the module housing; and a second barrier disposed on an outer surface of the module housing and including a plurality of through-holes. At least a portion of gas generated in the cell assembly is configured to be discharged to an outside of the module housing through the plurality of first venting portions, the plurality of venting holes, and the plurality of through-holes.

In an embodiment, the pack frame may include a pack cover covering the plurality of battery modules. The battery modules may further include a buffer pad disposed on the second barrier and configured to contact the pack cover.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a perspective view of a battery module according to an embodiment.

FIG. 3 is an exploded perspective view of a battery module according to an embodiment.

FIG. 4 is an exploded perspective view of a thermal barrier assembly according to an embodiment.

FIG. 5 is a schematic cross-sectional view of a thermal barrier assembly according to an embodiment.

FIG. 6 is an exploded perspective view of a thermal barrier assembly according to another embodiment.

FIG. 7 is a schematic cross-sectional view of a thermal barrier assembly according to another embodiment.

FIG. 8 is an exploded perspective view of a thermal barrier assembly according to another embodiment.

FIG. 9 is a perspective view of a battery module according to another embodiment.

FIG. 10 is an exploded perspective view of a battery pack according to an embodiment.

FIG. 11 is a schematic cross-sectional view of a battery pack according to an embodiment.

### DETAILED DESCRIPTION

Features of the present disclosure disclosed in this patent document are described by example embodiments with reference to the accompanying drawings.

Hereinafter, the present disclosure will be described in detail with reference to the attached drawings. However, this is merely illustrative and the present disclosure is not limited to the specific embodiments described as examples.

The terms or words used in the present specification and claims described below are not to be construed as limited to their conventional or dictionary meanings. The inventor will interpret them in the sense and concept that are consistent with the technical idea of the present disclosure based on the principle that the inventor may appropriately define the concept of the term in order to explain his or her own invention in the best way.

Therefore, it will be understood that the embodiments described in this specification and the configurations illustrated in the drawings are only the most preferred embodiments of the present disclosure and do not represent all of the technical ideas of the present disclosure, and that there may be various equivalents and modified examples that may replace them at the time of this application.

A detailed description of known functions and configurations that may obscure the gist of the present disclosure is omitted. In the attached drawings, some components are exaggerated, omitted, or schematically illustrated, and the size of each component does not entirely reflect the actual size.

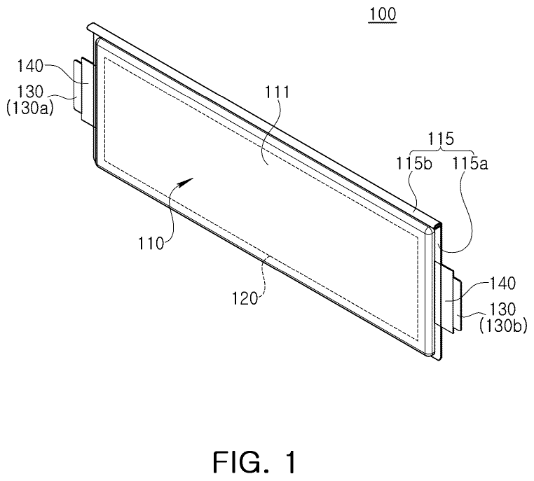

FIG. 1 is a perspective view of a battery cell according to an embodiment.

Referring to FIG. 1, the battery cell (100) may include a pouch (110), an electrode assembly (120), and an electrode tab (130). The battery cell (100) may be a secondary battery. For example, the battery cell (100) may be a lithium ion battery, but is not limited thereto. For example, the battery cell (100) may be a nickel-cadmium battery, a nickel-metal hydride battery, or a nickel-hydrogen battery that may be charged and discharged.

The pouch (110) may form at least a portion of the outer surface of the battery cell (100). The pouch (110) may include an electrode receiving portion (111) that accommodates the electrode assembly (120) and a sealing portion (115) that seals at least a portion of the periphery of the electrode receiving portion (111). The electrode receiving portion (111) may provide a space in which the electrode assembly (120) and the electrolyte are accommodated.

The sealing portion (115) may be formed by joining at least a portion of the periphery of the pouch (110). The sealing portion (115) is formed in a flange shape that extends outward from the electrode receiving portion (111) formed in a container shape, and may be disposed along at least a portion of the outer periphery of the electrode receiving portion (111). In an embodiment, the sealing portion (115) may include a first sealing portion (115a) where the electrode tab (130) is located and a second sealing portion (115b) where the electrode tab (130) is not located. A portion of the electrode tab (130) may be withdrawn or exposed to the outside of the pouch (110). At the position where the electrode tab (130) is withdrawn, in order to increase the sealing degree of the first sealing portion (115a) and at the same time secure an electrical insulation state, the electrode tab (130) may be covered by an insulating film (140). The insulating film (140) is made of a film material thinner than the electrode tab (130) and may be attached to both sides of the electrode tab (130).

The electrode tab (130) may transmit the current of the battery cell (100) to the outside of the battery cell (100). The electrode tab (130) may be connected to the electrode assembly (120). In an embodiment, the electrode tabs (130) may be disposed on opposite sides of the length direction of the battery cell (100). For example, the electrode tab (130) may include a first electrode tab (130a) (for example, a positive electrode tab) having a first polarity (for example, a positive electrode) facing one longitudinal side of the battery cell (100) and a second electrode tab (130b) having a second polarity (for example, a negative electrode) facing the other longitudinal side. In the embodiment illustrated in FIG. 1, the sealing portion (115) may include two first sealing portions (115a) on which the electrode tabs (130) are disposed and one second sealing portion (115b) on which the electrode tabs (130) are not disposed. The first sealing portion (115a) may seal at least a portion of the electrode tab (130). In an embodiment, the electrode tab (130) may be referred to as an electrode lead.

The direction in which the electrode tabs (130) are positioned may be selectively designed. For example, in FIG. 1, electrode tabs (130) are illustrated that are disposed to face opposite directions on both sides of the longitudinal direction of the battery cell (100), but the structure of the electrode tabs (130) is not limited thereto. For example, two electrode tabs (130) may be disposed substantially parallel along the longitudinal direction of the battery cell (100). The pouch (110) is not limited to a structure in which a single sheet of outer material is folded to form a sealing portion (115) on three sides as illustrated in FIG. 1. In an embodiment, at least a portion of the sealing portion (115) may be formed in a form that is folded at least once. By folding at least a portion of the sealing portion (115), the bonding reliability of the sealing portion (115) may be improved, and the area of the sealing portion (115) may be minimized. According to an embodiment, the second sealing portion (115b) in which the electrode tab (130) is not disposed among the sealing portions (115) may be fixed by an adhesive member (not illustrated) after being folded twice. The angle at which the second sealing portion (115b) is bent or the number of times it is bent may be changed. For example, in an embodiment not illustrated, the second sealing portion (115b) may be folded 90° with respect to the first sealing portion (115a).

The electrode assembly (120) may include a cathode plate, an anode plate, and a separator. The separator may prevent contact between the cathode plate and the anode plate. A person skilled in the art will understand that the electrode assembly (120) may be manufactured using various methods. According to example embodiments, the anode, the cathode, and the separator may be repeatedly disposed to form the electrode assembly. In some embodiments, the electrode assembly may be a winding type, a stacking type, a z-folding type, or a stack-folding type.

In the present disclosure, a pouch-type battery cell (100) is disclosed, but the structure of the battery cell (100) is illustrative. For example, the battery cell (100) of the present disclosure may be replaced with a cylindrical battery cell or a square battery cell.

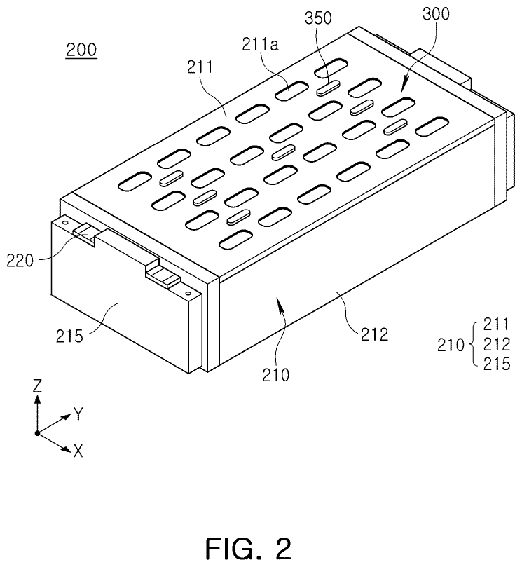

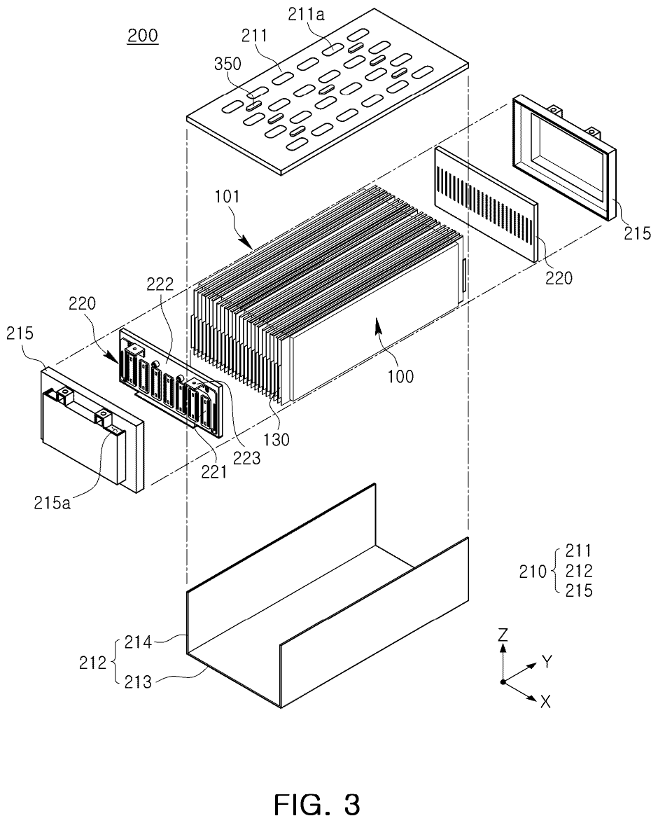

FIG. 2 is a perspective view of a battery module according to an embodiment. FIG. 3 is an exploded perspective view of a battery module according to an embodiment.

Referring to FIG. 2 and/or FIG. 3, the battery module (200) may include a cell assembly (101), a module housing (210), a busbar assembly (220), and a thermal barrier assembly (300).

The cell assembly (101) may include a plurality of battery cells (100). The cell assembly (101) may be placed within the module housing (210). The description of the battery cell (100) of FIG. 1 may be applied to the battery cell (100) of FIG. 3.

The cell assembly (101) may have a substantially hexahedral shape. In an embodiment, the cell assembly (101) may be referred to as a cell stack. In an embodiment, the cell assembly (101) may include a plurality of battery cells (100) connected using an adhesive tape. According to an embodiment, the cell assembly (101) may include a heat transfer prevention member (for example, a thermal barrier) positioned between at least some of the plurality of battery cells (100).

The module housing (210) may form at least a portion of the exterior of the battery module (200). The module housing (210) may accommodate a component (for example, a cell assembly (101)) of the battery module (200). For example, the module housing (210) may accommodate the cell assembly (101) and/or the busbar assembly (220). The module housing (210) may protect the cell assembly (101) from external impact.

The module housing (210) may include a module cover (211) that covers the cell assembly (101). For example, the module cover (211) may be disposed on one side of the cell assembly (101). The module cover (211) may cover a portion (for example, an upper portion) of the cell assembly (101). The module cover (211) may protect the cell assembly (101) from external impact of the battery module (200). In an embodiment, the module cover (211) may be referred to as a top cover.

The module housing (210) (for example, the module cover (211)) may include a plurality of venting holes (211a). The venting holes (211a) may provide a path for gases, flames, and/or conductive particles generated in a cell assembly (for example, the cell assembly (101) of FIG. 3) to be discharged to the outside of the battery module (200). By discharging gases, flames, and/or conductive particles inside the battery module (200) to the outside of the battery module (200), an explosion due to an increase in internal pressure of the battery module (200) may be prevented. In an embodiment, the venting holes (211a) may be through-holes formed in the module cover (211). In an embodiment (not illustrated), the venting holes (211a) may include notches or ruptures. The module cover (211) may be referred to as a part of the module housing (210). The module cover (211) may be referred to as a part of the thermal barrier assembly (300).

The module housing (210) may include a main plate (213) supporting the cell assembly (101) and a receiving portion (212) including a side wall (214) extending from the main plate (213). The receiving portion (212) may accommodate the cell assembly (101). In an embodiment, the main plate (213) may be referred to as a bottom plate. The cell assembly (101) may be mounted to the main plate (213). The side wall (214) may cover at least a portion of a side surface of the cell assembly (101). For example, the side wall (214) may extend from both ends of the main plate (213) toward a first direction (for example, +Z direction). In an embodiment, the side wall (214) may be formed integrally with the main plate (213).

The module housing (210) may be manufactured from a material that may be joined by welding. In an embodiment, the module housing (210) may be made of a material having high thermal conductivity, such as metal. For example, the module housing (210) may be formed of aluminum or stainless steel. However, the material of the module housing (210) is not limited thereto. The module housing (210) may be referred to as a battery case, a housing, or a module case.

The module housing (210) may include an end plate (215). The end plate (215) may face at least a portion of the cell assembly (101). In an embodiment, the end plate (215) may be coupled to the receiving portion (212) and/or the module cover (211). For example, the end plate (215) may be connected (for example, welded) to an end portion in the longitudinal direction (for example, in the X-axis direction) of the receiving portion (212) and/or the module cover (211). The end plate (215) may protect the cell assembly (101) from external impact of the battery module (200). The end plate (215) may cover a portion of the side surface of the cell assembly (101). In an embodiment, the end plate (215) may be referred to as a front case and/or a back case. The components of the module housing (210) may be joined to each other by welding. For example, the receiving portion (212), the module cover (211), and/or the end plate (215) may be welded to each other.

The busbar assembly (220) may be electrically connected to the cell assembly (101). For example, the busbar assembly (220) may include an internal busbar (221) connected to the cell assembly (101). The internal busbar (221) may be electrically connected to an electrode tab (130) of the battery cell (100). The busbar assembly (220) may include a busbar frame (222) supporting an inner busbar (221). At least a portion of the busbar assembly (220) may be disposed within the module housing (210). The busbar frame (222) may be formed of an electrically insulating material (for example, a polymer). The busbar frame (222) may include at least one fastening hole for receiving a fastening component (for example, a screw, a rivet, and/or a boss structure). By the fastening component, the busbar frame (222) may be fastened to the module housing (210). In an embodiment, the inner busbar (221) may be referred to as a busbar. The inner busbar (221) may be provided in multiple pieces. For example, the number of inner busbars (221) may be selectively designed based on the number of battery cells (100) included in the battery module (200).

The busbar assembly (220) may include at least one terminal busbar (223) for electrical connection to the outside. The electrode tab (130) of the battery cell (100) may be electrically connected to the outside of the battery module (200) through the inner busbar (221) and the terminal busbar (223). For example, the terminal busbar (223) may be electrically connected to the inner busbar (221), and the current of the battery cell (100) may be transmitted to the outside of the battery module (200) through the inner busbar (221) and the terminal busbar (223). At least a portion of the terminal busbar (223) may be exposed to the outside of the module housing (210).

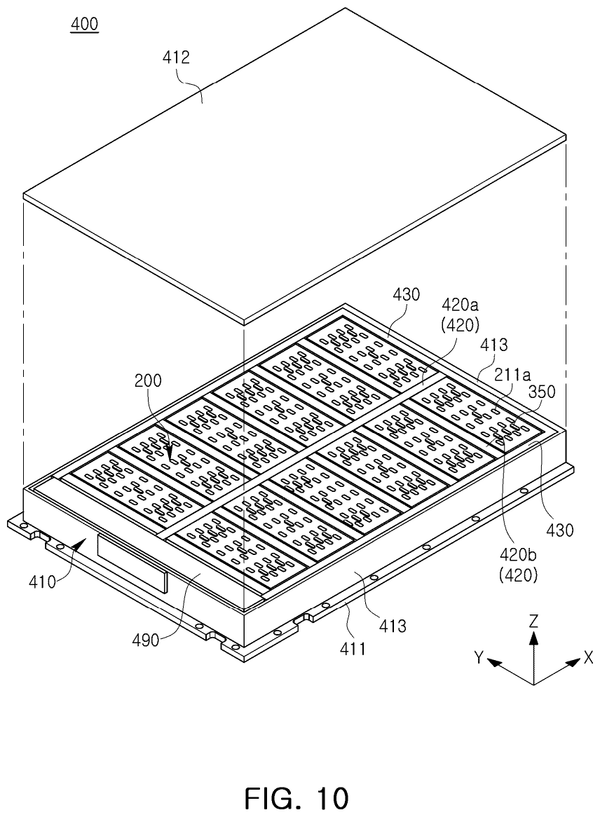

The thermal barrier assembly (300) may prevent heat transfer between the battery modules (200) due to the rebound effect. For example, the thermal barrier assembly (300) may prevent a phenomenon in which a substance (for example, gas, flame, and/or conductive particles) discharged from the inside of the battery module (200) to the outside of the battery module (200) is reflected by a structure of a battery pack (for example, battery pack (400) of FIG. 10) and transmitted to the inside of the battery module (200). In an embodiment, the thermal barrier assembly (300) may include a module cover (211) and a buffer pad (350). The buffer pad (350) may be attached to an outer surface of the module cover (211). The thermal barrier assembly (300) is further described below.

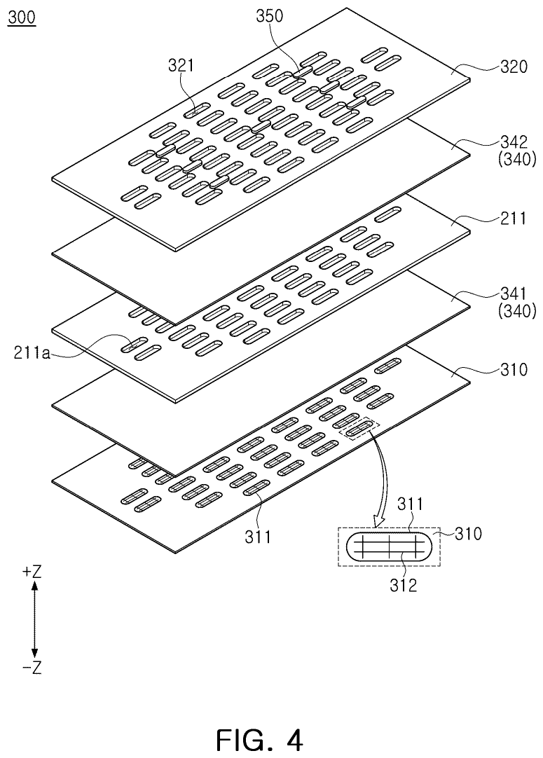

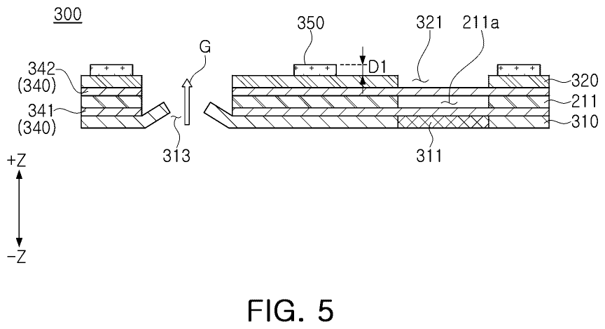

FIG. 4 is an exploded perspective view of a thermal barrier assembly according to an embodiment. FIG. 5 is a schematic cross-sectional view of a thermal barrier assembly according to an embodiment.

Referring to FIG. 4 and/or FIG. 5, the thermal barrier assembly (300) may include a module cover (211), a first barrier (310), a second barrier (320), an adhesive layer (340), and/or a buffer pad (350). The description of the module cover (211), the venting hole (211a), the thermal barrier assembly (300), and the buffer pad (350) of FIG. 2 and/or FIG. 3 may be applied to the module cover (211), the venting hole (211a), the thermal barrier assembly (300), and the buffer pad (350) of FIG. 4 and/or FIG. 5.

The first barrier (310) may be disposed on the inner surface of the module housing (210). The first barrier (310) may include a plurality of first venting portions (311) configured to be deformed based on the pressure inside the module housing (210). The first barrier (310) may be positioned between the module housing (210) and the cell assembly (for example, the cell assembly (101) of FIG. 4). For example, the first barrier (310) may be positioned on the inner surface of the module housing (210) (for example, the module cover (211)). In an embodiment, one surface of the module cover (211) facing the second direction (-Z direction) may be referred to as the inner surface of the module cover (211), and the other surface of the module cover (211) facing the first direction (+Z direction) may be referred to as the outer surface of the module cover (211). In an embodiment, the first barrier (310) may be referred to as a first thermal barrier.

The first barrier (310) may induce the discharge of gas (G), flame, and/or conductive particles in the battery module (200) where an event (for example, fire) has occurred. The first barrier (310) may be formed so that at least a portion thereof is opened when the interior of the battery module (200) is at least at a specified pressure. For example, the first venting portion (311) may have a shape that may be deformed (for example, ruptured) based on the pressure inside the battery module (200). In an embodiment, the plurality of first venting portions (311) may each include a first deformable portion (312) formed in a notching, half-cut, engraved, or plate shape. When the interior of the battery module (200) is at least at a specified pressure, at least a portion of the first deformable portion (312) may be deformed to form a first opening (313). The first opening (313) may provide a passage through which gas (G) passes. In an embodiment, the first deformation portion (312) may be referred to as the first vulnerable portion or the first rupture portion. In an embodiment, the first venting portion (311) may be formed to have breathability. In an embodiment, the first barrier (310) may be manufactured from a flexible material. The size, arrangement, number, and/or shape of the first venting portion (311) of the present disclosure are illustrative.

In an embodiment, the sum of the cross-sectional areas of the plurality of first venting portions (311) may be formed to have an area for flames, gas (G), and/or conductive particles generated in the battery module (200) to be discharged to the outside of the battery module (200). For example, the sum of the cross-sectional areas of the plurality of first venting portions (311) may be 30% or more of the area of one side (for example, the front or back) of the first barrier (310).

The first barrier (310) may be made of a material for electrical insulation and heat resistance. For example, the first barrier (310) may include at least one of glass fiber, silicon (for example, a silicon sheet), ceramic (for example, a ceramic sheet), or aerogel (for example, an aerogel sheet).

The second barrier (320) may protect the battery module (200). For example, the second barrier (320) may prevent flames, gases (G), and/or conductive particles discharged from a battery module (200) in a ignition state from being reflected from the external structure of the battery module (200) and transmitted to the interior of the battery module (200) that is not ignited. The second barrier (320) may protect the cell assembly (101) from foreign substances at high temperature and/or high pressure. The first barrier (310) and/or the second barrier (320) may prevent insulation breakdown and external short circuits due to foreign substances (for example, conductive particles) transmitted from the outside of the battery module (200). In an embodiment, the second barrier (320) may be referred to as a second thermal barrier.

The second barrier (320) may provide a path for substances (for example, gas (G), flames, and/or conductive particles) passing through the venting hole (211a) of the module housing (210) (for example, module cover (211)) and/or the first venting portion (311) of the first barrier (310). For example, the second barrier (320) may include a plurality of through- holes (321) facing each of the plurality of venting holes (211a). At least a portion of the gas (G) generated in the cell assembly (101) (or flame, and/or conductive particles) may be discharged to the outside of the module housing (for example, the module housing (210) of FIG. 2) through the plurality of first venting portions (311), the plurality of venting holes (211a), and the plurality of through-holes (321). The plurality of venting holes (211a) may be positioned between the plurality of first venting portions (311) and the plurality of through-holes (321), respectively.

The second barrier (320) may be disposed on the outer surface of the module housing (210). For example, the second barrier (320) may be disposed on the outer surface of the module cover (211).

The second barrier (320) may be manufactured from a material for heat resistance and insulation. For example, the second barrier (320) may include at least one of mica (for example, muscovite, gold and silver, vermiculite), and mineral wool (or rock wool). The second barrier (320) may be manufactured as a substantially rigid body. For example, the flexibility of the first barrier (310) may be lower than the flexibility of the second barrier (320).

The adhesive layer (340) may connect the barriers (310, 320) to the module housing (210) (for example, the module cover (211)). For example, the adhesive layer (340) may include a first adhesive layer (341) connecting the first barrier (310) and the module housing (210) (for example, the module cover (211)) and a second adhesive layer (342) connecting the second barrier (320) and the module housing (210) (for example, the module cover (211)). The first adhesive layer (341) may be positioned between the module cover (211) and the first barrier (310). The second adhesive layer (342) may be positioned between the module cover (211) and the second barrier (320). In an embodiment, at least a portion of the adhesive layer (340) (for example, a portion of the adhesive layer (340) facing the first venting portion (311)) may be melted by a material (for example, a gas (G)) discharged from the cell assembly (101).

The buffer pad (350) may prevent deformation (for example, bending) of the thermal barrier assembly (300). For example, the buffer pad (350) may be disposed on the second barrier (320) and configured to be in contact with an external structure (for example, pack frame (410) of FIG. 10) of the battery module (200). When the internal pressure of the battery module (200) is greater than a specified size, at least a portion of the battery module (200) may be expanded. As the buffer pad (350) comes into contact with the external structure of the battery module (200), deformation of the second barrier (320) may be reduced. As deformation of the second barrier (320) is reduced, deformation of the first barrier (310) may be prevented. When the barrier (310, 320) is deformed, gas (G) and/or flame of the battery module (200) may be discharged through the gap between the first barrier (310), the module housing (210), and/or the second barrier (320), and a short circuit may occur in the battery module (200). The buffer pad (350) may reduce the deformation of the barrier (310, 320), thereby reducing the risk of a short circuit occurring in the battery module (200). In an embodiment, the buffer pad (350) may be referred to as a pressurized pad.

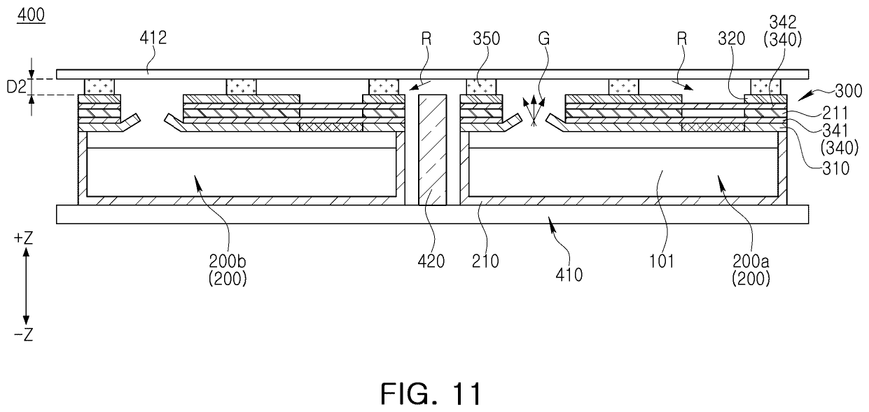

The buffer pad (350) may be placed on the second barrier (320) in a compressed state. For example, the thickness (D1) of the buffer pad (350) may be longer than the gap (for example, the gap (D2) of FIG. 11) between the second barrier (320) and an external structure of the battery module (200) (for example, the pack cover (412) of FIG. 11). In an embodiment, the thickness (D1) of the buffer pad (350) may be about 10 mm, and the gap (D2) between the second barrier (320) of the battery module (200) and the pack cover (412) may be about 5 mm. The length of the buffer pad (350) in the first direction (+Z direction) or the second direction (−Z direction) may be referred to as the thickness (D1) of the buffer pad (350). The deformation of the thermal barrier assembly (300) may be prevented by the repulsive force of the buffer pad (350) in a compressed state.

The buffer pads (350) may be disposed at positions to reduce deformation of the barriers (310, 320). In an embodiment, the buffer pads (350) are provided as a plurality of buffer pads (350), some of the plurality of buffer pads (350) may be disposed adjacent to the center of the second barrier (320), and other some of the plurality of buffer pads (350) may be disposed adjacent to the edge of the second barrier (320). In an embodiment, the number of the plurality of buffer pads (350) disposed on the center of the second barrier (320) may be greater than the number of the plurality of buffer pads (350) disposed on the center of the second barrier (320).

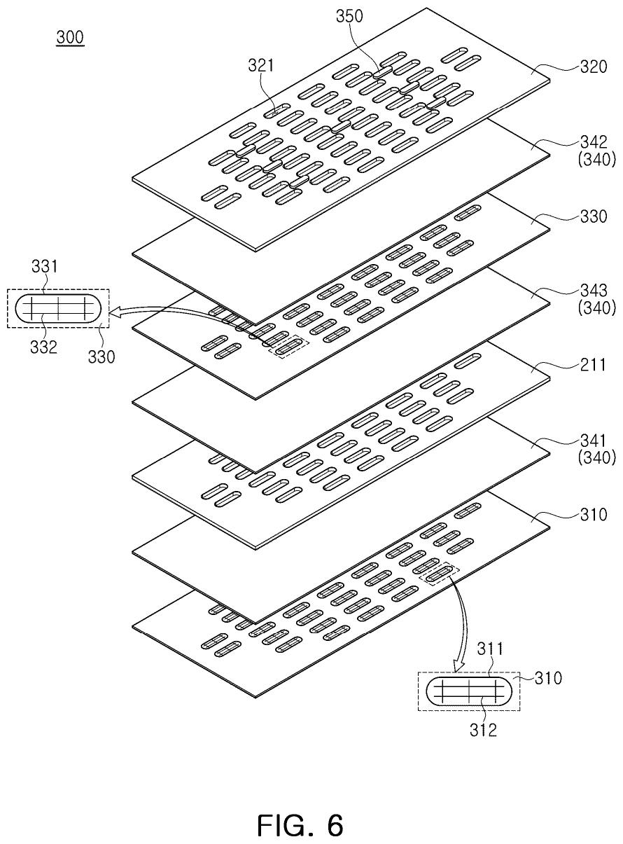

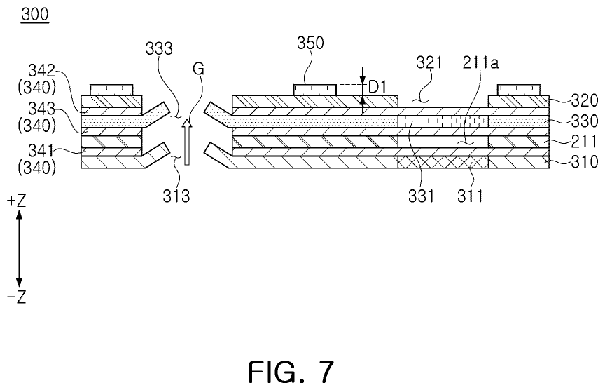

FIG. 6 is an exploded perspective view of a thermal barrier assembly according to another embodiment. FIG. 7 is a schematic cross-sectional view of a thermal barrier assembly according to another embodiment.

Referring to FIG. 6 and/or FIG. 7, the thermal barrier assembly (300) may include a module cover (211), a first barrier (310), a second barrier (320), a third barrier (330), an adhesive layer (340), and a buffer pad (350). The description of the module cover (211), the thermal barrier assembly (300), the first barrier (310), the second barrier (320), the adhesive layer (340), and the buffer pad (350) of FIG. 2, FIG. 3, FIG. 4, and/or FIG. 5 may be applied to the module cover (211), the thermal barrier assembly (300), the first barrier (310), the second barrier (320), the adhesive layer (340), and the buffer pad (350) of FIG. 6 and/or FIG. 7.

The third barrier (330) may be disposed on the outer surface of the module housing (210). The third barrier (330) may include a plurality of second venting portions (331) configured to be deformed based on the pressure inside the module housing (210). In an embodiment, the third barrier (330) may be referred to as a third thermal barrier.

The third barrier (330) may be located between the module housing (210) and the second barrier (320). For example, the third barrier (330) may be disposed on an outer surface of the module housing (210) (for example, the module cover (211)). In an embodiment, one surface of the module cover (211) facing the second direction (−Z direction) may be referred to as an inner surface of the module cover (211), and the other surface of the module cover (211) facing the first direction (+Z direction) may be referred to as an outer surface of the module cover (211). The third barrier (330), together with the first barrier (310) and/or the second barrier (320), may prevent insulation breakdown and external short circuits caused by conductive particles.

The third barrier (330) may provide a path for gas (G), flame, and/or conductive particles generated in the cell assembly (for example, the cell assembly (101) of FIG. 4) to pass through, together with the module housing (210) (for example, the module cover (211), the first barrier (310), and the second barrier (320). For example, the second venting portion (331) of the third barrier (330) may face the venting hole (211a) of the module cover (211), the first venting portion (311) of the first barrier (310), and the through-hole (321) of the second barrier (320). The second venting portion (331) may be located between the through-hole (321) of the second barrier (320) and the venting hole (211a) of the module cover (211). For example, a plurality of second venting portions (331) may face the plurality of venting holes (211a), respectively.

The third barrier (330) may induce the discharge of gas, flame, and/or conductive particles in the battery module (200) where an event (for example, fire) has occurred. The third barrier (330) may be formed so that at least a portion thereof is opened when the interior of the battery module (200) is at least at a specified pressure. For example, the second venting portion (331) may have a shape that may be deformed (for example, ruptured) based on the pressure inside the battery module (200). In an embodiment, the second venting portion (331) may include a second deformable portion (332) formed in a notching, half- cut, engraving, or plate shape. When the interior of the battery module (200) is at least at a specified pressure, at least a portion of the second deformable portion (332) may be deformed to form a second opening (323). The second opening (323) may provide a passage through which gas (G) passes. In an embodiment, the second deformation portion (332) may be referred to as the second vulnerable portion or the second rupture portion. In an embodiment, the second venting portion (331) may be formed to have breathability. In an embodiment, the third barrier (330) may be made of a flexible material. The size, arrangement, number, and/or shape of the second venting portion (331) of the present disclosure are illustrative.

In an embodiment, the sum of the cross-sectional areas of the plurality of second venting portions (331) may be formed to have an area for flames, gases, and/or conductive particles generated in the battery module (200) to be discharged to the outside of the battery module (200). For example, the sum of the cross-sectional areas of the plurality of second venting portions (331) may be 30% or more of the area of one side (for example, the front or back) of the third barrier (330).

The third barrier (330) may be made of a material for electrical insulation and heat resistance. For example, the third barrier (330) may include at least one of glass fiber, silicone (for example, silicone sheet), ceramic (for example, ceramic sheet), or aerogel (for example, aerogel sheet).

The adhesive layer (340) may connect the components of the thermal barrier assembly (300) (for example, module housing (for example, module cover (211)), first barrier (310), second barrier (320), third barrier (330)) to each other. For example, the adhesive layer (340) may include a first adhesive layer (341) connecting the first barrier (310) and the module housing (210) (for example, the module cover (211)), a second adhesive layer (342) connecting the second barrier (320) and the third barrier (330), and a third adhesive layer (343) connecting the third barrier (330) and the module housing (for example, the module cover (211)). The first adhesive layer (341) may be positioned between the module cover (211) and the first barrier (310). The second adhesive layer (342) may be positioned between the second barrier (320) and the third barrier (330). A third adhesive layer (343) may be positioned between the third barrier (330) and the module housing (for example, module cover (211)).

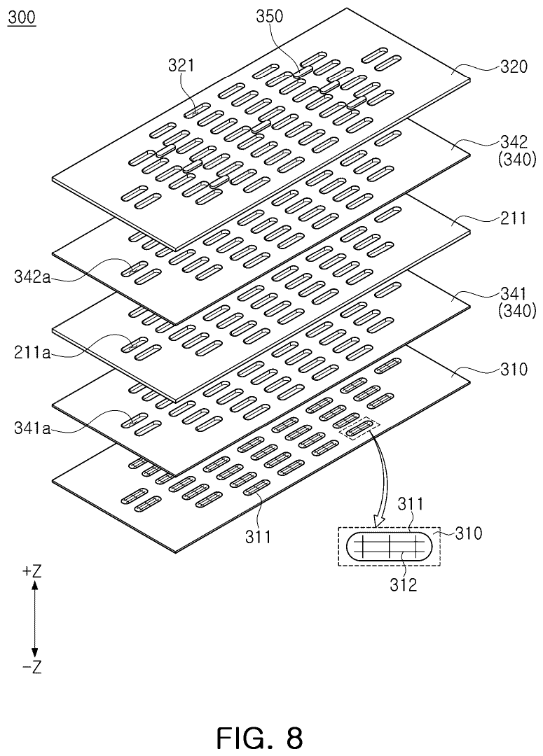

FIG. 8 is an exploded perspective view of a thermal barrier assembly according to another embodiment.

Referring to FIG. 8, the thermal barrier assembly (300) may include a module cover (211), a first barrier (310), a second barrier (320), a third barrier (330), an adhesive layer (340), and a buffer pad (350). The descriptions of the module cover (211), the thermal barrier assembly (300), the first barrier (310), the second barrier (320), the adhesive layer (340), and the buffer pad (350) of FIG. 2, FIG. 3, FIG. 4, and/or FIG. 5 may be applied to the module cover (211), the thermal barrier assembly (300), the first barrier (310), the second barrier (320), the adhesive layer (340), and the buffer pad (350) of FIG. 8.

The adhesive layer (340) may be formed in a shape to provide a path for gas (for example, gas (G) of FIG. 5), flame, and/or conductive particles generated from the cell assembly (for example, cell assembly (101) of FIG. 3). For example, the adhesive layer (340) may include holes (341a, 342a). For example, the first adhesive layer (341) may include a first hole (341a) positioned between a plurality of first venting holes (211a) and a plurality of first venting portions (311). The first holes (341a) may be provided in multiple numbers. In an embodiment, the plurality of first holes (341a) may face the plurality of first venting holes (211a) and the plurality of first venting portions (311), respectively. The second adhesive layer (342) may include a second hole (342a) positioned between a plurality of first venting holes (211a) and a plurality of second venting portions (331). The second holes (342a) may be provided in plurality. In an embodiment, the plurality of second holes (342a) may face the plurality of first venting holes (211a) and the plurality of second venting portions (331), respectively. Flames, gases, and/or conductive particles generated in the cell assembly (for example, the cell assembly (101) of FIG. 3) may be discharged to the outside of the battery module (200) through the first venting portion (311) of the first barrier (310) (for example, the first opening (313)), the first hole (341a) of the first adhesive layer (341), the venting hole (211a) of the module cover (211), the second hole (342a) of the second adhesive layer (342), and the through-hole (321) of the second barrier (320).

At least part of the description of the first hole (341a) and the second hole (342a) described in FIG. 8 may be applied to the third adhesive layer (343) of FIG. 6 and/or FIG. 7. For example, in an embodiment not illustrated, the third adhesive layer (343) may include a third hole (not illustrated) located between the second venting portion (331) of the third barrier (330) and the venting hole (211a) of the module cover (211). Flames, gases, and/or conductive particles generated in the cell assembly (for example, the cell assembly (101) of FIG. 3) may be discharged to the outside of the battery module (200) through the first venting portion (311) of the first barrier (310) (for example, the first opening (313)), the first hole (341a) of the first adhesive layer (341), the venting hole (211a) of the module cover (211), the third hole (not illustrated) of the third adhesive layer (343), the second venting portion (331) of the third barrier (330) (for example, the second opening (333) of FIG. 7), the second hole (342a) of the second adhesive layer (342), and the through-hole (321) of the second barrier (320).

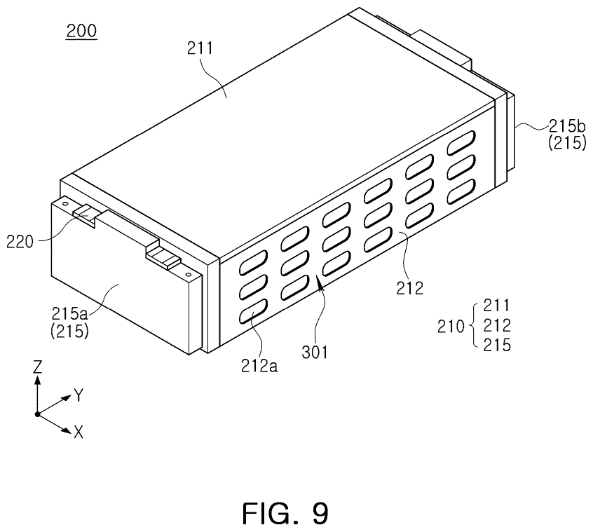

FIG. 9 is a perspective view of a battery module according to another embodiment.

Referring to FIG. 9, the battery module (200) may include a module housing (210), a busbar assembly (220), and a thermal barrier assembly (301). At least some of the descriptions of the battery module (200), the module housing (210), the busbar assembly (220), and the thermal barrier assembly (300) of FIG. 2 and/or FIG. 3 may be applied to the battery module (200), the module housing (210), the busbar assembly (220), and the thermal barrier assembly (301) of FIG. 9.

In an embodiment, the thermal barrier assembly (301) may be mounted on a side surface (for example, in the X-axis direction) of the battery module (200). For example, the module housing (210) may include a module cover (211), a receiving portion (212), and an end plate (215). The side wall (for example, the side wall (214) of FIG. 3) of the receiving portion (212) may include a plurality of venting holes (212a). The venting holes (212a) may provide a path for gases, flames, and/or conductive particles generated in the cell assembly (for example, the cell assembly (101) of FIG. 3) to be discharged to the outside of the battery module (200).

In an embodiment, the thermal barrier assembly (301) may include a receiving portion (212), a first barrier (for example, the first barrier (310) of FIG. 4), a second barrier (for example, the second barrier (320) of FIG. 4), and an adhesive layer (for example, the adhesive layer (340) of FIG. 4). At least some of the descriptions of the thermal barrier assembly (300), the first barrier (310), the second barrier (320), and the adhesive layer (340) of FIGS. 4 to 8 may be applied to the thermal barrier assembly (301) of FIG. 9. For example, the first barrier (310) may be disposed on an inner surface of the receiving portion (212) (for example, the sidewall (214) of FIG. 3), and the second barrier (320) may be disposed on an outer surface of the sidewall (214). One side of the receiving portion (212) facing the cell assembly (101) may be referred to as the inner surface of the receiving portion (212), and the other side of the receiving portion (212) facing the outside of the battery module (200) may be referred to as the outer surface of the receiving portion (212). The adhesive layer may include a fourth adhesive layer (not illustrated) connecting the first barrier (310) and the receiving portion, and a fifth adhesive layer (not illustrated) connecting the second barrier (320) and the receiving portion.

In an embodiment, the end plate (215) may include a front cover (215a) and a rear cover (215b). The front cover (215a) may accommodate a part of the busbar assembly (220) (for example, terminal busbar (223) of FIG. 3). The rear cover (215b) may be a cover spaced apart from the terminal busbar (223). According to an embodiment (not illustrated), the thermal barrier assembly (301) may be located at the rear of the battery module (200). For example, the thermal barrier assembly (301) may include a rear cover (215b) of the end plate (215), a first barrier (for example, the first barrier (310) of FIG. 4), a second barrier (for example, the second barrier (320) of FIG. 4), and an adhesive layer (for example, the adhesive layer (340) of FIG. 4).

At least some of the descriptions of the thermal barrier assembly (300), the first barrier (310), the second barrier (320), and the adhesive layer (340) of FIGS. 4 to 8 may be applied to the thermal barrier assembly (301) of FIG. 9. For example, the first barrier (310) may be disposed on the inner surface of the rear cover (215b), and the second barrier (320) may be disposed on the outer surface of the rear cover (215b). One surface of the rear cover (215b) facing the cell assembly (101) and/or the busbar assembly (for example, the busbar assembly (220) of FIG. 3) may be referred to as the inner surface of the rear cover (215b), and the other surface of the rear cover (215b) facing the exterior of the battery module (200) may be referred to as the outer surface of the rear cover (215b). The adhesive layer may include a sixth adhesive layer (not illustrated) connecting the first barrier (310) and the rear cover (215b), and a seventh adhesive layer (not illustrated) connecting the second barrier (320) and the rear cover (215b).

FIG. 10 is an exploded perspective view of a battery pack according to an embodiment. FIG. 11 is a schematic cross-sectional view of a battery pack according to an embodiment.

Referring to FIG. 10 and/or FIG. 11, a battery pack (400) may include a plurality of battery modules (200), and a pack frame (410) that accommodates the plurality of battery modules (200). The description of the battery module (200) previously described may be applied to the battery module (200) of FIG. 10 and/or FIG. 11. For example, the battery module (200) of FIG. 10 and/or FIG. 11 may include a cell assembly (101), a module housing (210), and a thermal barrier assembly (300) (for example, the thermal barrier assembly (300) of FIGS. 4 to 8). The thermal barrier assembly (300) may include a module cover (211), a first barrier (310), a second barrier (320), a first adhesive layer (341), and a second adhesive layer (342).

The thermal barrier assembly (300) may prevent heat transmission between battery modules (200) due to a rebound effect. For example, the plurality of battery modules (200) may include a first battery module (200a) and a second battery module (200b) spaced apart from the first battery module (200a). For example, the first battery module (200a) may be spaced apart from the second battery module (200b) with a partition wall (420) therebetween. In an embodiment, among the plurality of battery modules (200), a battery module (200) in which a thermal event has occurred may be referred to as a first battery module (200a), and a battery module (200) adjacent to the first battery module (200a) and in which a thermal event has not occurred may be referred to as a second battery module (200b). The thermal barrier assembly (300) may prevent a rebound effect. For example, in a battery module (200) including a thermal barrier assembly (300), it has been confirmed that in a situation in which a thermal event has occurred in the first battery module (200a), the voltage of the second battery module (200b) is gradually lowered.

In an embodiment, gas (G) discharged through the thermal barrier assembly (300) of the first battery module (200a) may come into contact with a part of the pack frame (410) (for example, pack cover (412)). The rebound gas (R) reflected on the pack cover (412) may be transmitted to the second battery module (200b) adjacent to the first battery module (200a). The thermal barrier assembly (300) of the second battery module (200b) may prevent the inflow of the rebound gas (R). For example, when the pressure inside the first battery module (200a) is greater than a specified size, the first venting portion (for example, the first venting portion (311) of FIG. 4) of the first barrier (310) of the thermal barrier assembly (300) of the first battery module (200a) is opened, and gas (G) discharged from the cell assembly (101) may pass through the first venting portion (311), the venting hole (211a) of the module cover (211), and the through-hole (321) of the second barrier (320) to be discharged to the outside of the first battery module (200a).

When the rebound gas (R) comes into contact with the thermal barrier assembly (300) (for example, the first venting portion (310)) of the second battery module (200b), the thermal barrier assembly (300) of the second battery module (200b) may protect the cell assembly (101) from the rebound gas (R). For example, when the rebound gas (R) comes into contact with the thermal barrier assembly (300) (for example, the first venting portion (310)) of the second battery module (200b), the second barrier (320) may reduce the contact of the rebound gas (R) with the first barrier (310) and/or the cell assembly (101). The pressure of the rebound gas (R) may be lower than the pressure of the gas (G). When the rebound gas (R) comes into contact with the thermal barrier assembly (300) (for example, the first venting portion (310)) of the second battery module (200b), the first venting portion (311) of the second battery module (200b) may not be opened but may be maintained in a closed state. By the thermal barrier assembly (300), heat transmission between the plurality of battery modules (200) may be delayed and thermal runaway may be prevented.

The pack frame (410) may accommodate components of the battery pack (400) (for example, the battery module (200)). The pack frame (410) may include a bottom member (411) that supports the battery module (200), a pack cover (412) that covers the battery module (200), and a pack side wall (413) that surrounds at least a portion of the bottom member (411) and the pack cover (412). The bottom member (411) may support the battery module (200).

The buffer pad (350) may be placed on the second barrier (320) in a compressed state. For example, the thickness (D1) of the buffer pad (350) may be longer than the gap (D2) between the second barrier (320) and the pack cover (412). The length of the buffer pad (350) in the first direction (+Z direction) or the second direction (−Z direction) in an uncompressed state may be referred to as the thickness (D1) of the buffer pad (350). The deformation of the thermal barrier assembly (300) may be prevented by the repulsive force of the buffer pad (350) in the compressed state.

The pack frame (410) may include a partition (420) that crosses at least some of the plurality of battery modules (200). For example, the receiving space of the pack frame (410) may be divided into a plurality of spaces by the bulkhead (420). The bulkhead (420) may be installed across the receiving space to reinforce the rigidity of the pack frame (410). In an embodiment, the bulkhead (420) may include a first bulkhead (420a) that crosses a plurality of battery cells (100) and a plurality of second bulkheads (420b) that are substantially perpendicular to the first bulkhead (420a).

In an embodiment, the battery pack (400) may include a duct member (430). The duct member (430) may include an exhaust space for providing a path for gas and/or flame discharged from the battery module (200). The duct member (430) may be disposed within the pack frame (410). The duct member (430) may surround at least a portion of the battery module (200). For example, gas and/or flame generated from a battery cell (for example, battery cell (100) of FIG. 1) of a battery module (200) may be transferred to the outside of the battery pack (400) through the exhaust space of the duct member (430). In the present disclosure, the duct member (430) may be referred to as an exhaust duct or an exhaust member.

According to an embodiment, the battery pack (400) may include a pack cooling plate (not illustrated) for cooling the battery module (200). For example, at least a portion of the heat generated from the battery cell (100) of the battery module (200) may be transferred to the pack cooling plate. At least a portion of the heat transferred to the pack cooling plate may be discharged to the outside of the battery pack (400) through the pack frame (410). The pack cooling plate may be a water-cooled or air-cooled cooling member. In an embodiment, the pack cooling plate may be located between a plurality of battery modules (200) and the pack frame (410). For example, the pack cooling plate may be positioned between a plurality of battery modules (200) and a bottom member (411) of the pack frame (410). As another example, the pack cooling plate may be positioned between a plurality of battery modules (200) and a pack cover (412).

The battery pack (400) may include a battery control unit (490) for controlling the battery modules (200). The battery control unit (490) may be positioned within the pack frame (410). The battery control unit (490) may include a battery management system (BMS). The configuration of the battery control unit (490) is known in various forms, so a detailed description thereof will be omitted. In an embodiment, the battery control unit (490) may be referred to as a processor.

The structure of the battery pack (400) of FIG. 11 is illustrative. For example, the number of battery modules (200) included in the battery pack (400), the structure of the pack frame (410) and/or the duct member (430) may be selectively designed.

As set forth above, according to an embodiment, heat propagation between battery modules may be delayed, and thermal runaway between battery modules may be prevented.

According to an embodiment, rebound effect due to the structure of a battery pack may be prevented.

The above-described contents are merely examples of applying the principles of the present disclosure, and other configurations may be further included without departing from the scope of the present disclosure.

Only specific examples of implementations of certain embodiments are described. Variations, improvements and enhancements of the disclosed embodiments and other embodiments may be made based on the disclosure of this patent document. For example, the present disclosure may be implemented by deleting some of the components in the above-described embodiments, and respective embodiments may be implemented in combination with each other.

What is claimed is:

1. A battery module comprising:
a cell assembly including a plurality of battery cells;
a module housing accommodating the cell assembly and including a plurality of venting holes;
a first barrier disposed on an inner surface of the module housing and including a plurality of first venting portions configured to deform based on pressure inside the module housing; and
a second barrier disposed on an outer surface of the module housing and including a plurality of through-holes,
wherein at least a portion of gas generated in the cell assembly is configured to be discharged to an outside of the module housing through the plurality of first venting portions, the plurality of venting holes, and the plurality of through-holes.

2. The battery module of claim 1, wherein the plurality of venting holes are respectively positioned between the plurality of first venting portions and the plurality of through-holes.

3. The battery module of claim 1, wherein the plurality of first venting portions each include a first deformable portion formed in a notching, half-cut, engraving, or plate shape.

4. The battery module of claim 1, further comprising a buffer pad disposed on the second barrier and configured to contact an external structure of the battery module.

5. The battery module of claim 1, wherein the first barrier includes at least one of glass fiber, silicon, ceramic, or aerogel.

6. The battery module of claim 1, wherein the second barrier includes at least one of mica and mineral fiber.

7. The battery module of claim 1, further comprising an adhesive layer including a first adhesive layer connecting the first barrier and the module housing, and a second adhesive layer connecting the second barrier and the module housing.

8. The battery module of claim 7, wherein the first adhesive layer includes a first hole positioned between the plurality of venting holes and the plurality of first venting portions, and
the second adhesive layer includes a second hole positioned between the plurality of venting holes and the plurality of through-holes.

9. The battery module of claim 1, further comprising a third barrier disposed between the second barrier and the module housing and including a plurality of second venting portions configured to deform based on pressure inside the module housing,
wherein the plurality of second venting portions each face the plurality of venting holes, and
the plurality of second venting portions each include a second deformable portion formed in a notching, half-cut, engraving, or plate shape.

10. The battery module of claim 9, wherein the battery module includes an adhesive layer including a first adhesive layer connecting the first barrier and the module housing, a second adhesive layer connecting the second barrier and the third barrier, and a third adhesive layer connecting the third barrier and the module housing.

11. The battery module of claim 9, wherein the third barrier includes at least one of glass fiber, silicon, ceramic, or aerogel.

12. The battery module of claim 1, wherein the module housing includes a module cover covering the cell assembly and having a plurality of venting holes formed therein,
the first barrier is disposed on an inner surface of the module cover, and
the second barrier is disposed on an outer surface of the module cover.

13. The battery module of claim 1, wherein the module housing includes a main plate supporting the cell assembly and a side wall extending from the main plate and having the plurality of venting holes formed therein,
the first barrier is disposed on the inner surface of the side wall, and
the second barrier is disposed on the outer surface of the side wall.

14. A battery pack comprising:
a plurality of battery modules; and
a pack frame accommodating the plurality of battery modules,
wherein each of the plurality of battery modules includes,
a cell assembly including a plurality of battery cells,
a module housing accommodating the cell assembly and including a plurality of venting holes,
a first barrier disposed on an inner surface of the module housing and including a plurality of first venting portions configured to deform based on pressure inside the module housing; and
a second barrier disposed on an outer surface of the module housing and including a plurality of through-holes, and
at least a portion of gas generated in the cell assembly is configured to be discharged to an outside of the module housing through the plurality of first venting portions, the plurality of venting holes, and the plurality of through-holes.

15. The battery pack of claim 14, wherein the pack frame includes a pack cover covering the plurality of battery modules, and
the battery module further includes a buffer pad disposed on the second barrier and configured to contact the pack cover.
